(19) United States
(12) Patent Application Publication
(10) Pub. No.: US 2025/0012575 A1
(43) Pub. Date: Jan. 9, 2025

(54) CONTROL SYSTEM, CONTROL METHOD, AND RECORDING MEDIUM

(71) Applicant: NEC Corporation, Minato-ku, Tokyo (JP)

(72) Inventors: Akira TADA, Tokyo (JP); Hiroki SUGEGAYA, Tokyo (JP); Yuki TONO, Tokyo (JP); Akihiko ONITA, Tokyo (JP)

(73) Assignee: NEC Corporation, Minato-ku, Tokyo (JP)

(21) Appl. No.: 18/711,188

(22) PCT Filed: Dec. 7, 2021
(86) PCT No.: PCT/JP2021/044901

§ 371 Date: May 17, 2024

(51) Int. Cl. G01C 21/20; H04W 4/029

(52) U.S. Cl. CPC G01C 21/206; H04W 4/029

(57) ABSTRACT

This control system comprises a position identification unit, a route identification unit, an extraction unit, and an output control unit. The position identification unit identifies the position of a subject person within a facility. The route identification unit identifies a route from the identified position to the position of a subject component. The extraction unit extracts an electronic shelf tag located along the route on the basis of position information indicating the positions of electronic shelf tags within the facility. The output control unit controls the output of the extracted electronic shelf tag.

### TECHNICAL FIELD

The present disclosure relates to a control system and the like.

### BACKGROUND ART

In facilities such as stores or factories, information about items on shelves is often displayed on electronic shelf labels. Using a store as an example, information such as a price and a product name of a product located near the electronic shelf label is displayed on the electronic shelf label attached to the shelf. Display content can be easily changed compared to, for example, a paper price tag.

As a technique related to an electronic shelf label, PTL1 discloses a technique of controlling turning-on or off of a light emitting diode (LED) light source of an information display device in accordance with an order from a fixedly arranged reception terminal to a product designated in the reception terminal.

### CITATION LIST

### Patent Literature

PTL 1: JP 2013-50923 A

### SUMMARY OF INVENTION

### Technical Problem

There are cases in which it is difficult to find items within a facility. For example, in a case in which a path from a fixedly arranged device to an item is present, a person who is searching for an item may become confused with the path if he/she deviates from the path.

It is an object of the present disclosure to provide a control system and the like that facilitate guidance to an item in a facility.

### Solution to Problem

A control system according to an aspect of the present disclosure includes a position specifying means for specifying a position of a target person in a facility, a path specifying means for specifying a path from the specified position to a position of a target item, an extracting means for extracting an electronic shelf label on the path based on position information indicating a position of each electronic shelf label in the facility, and an output control means for controlling an output of the extracted electronic shelf label.

A control method according to an aspect of the present disclosure includes specifying a position of a target person in a facility, specifying a path from the specified position to a position of a target item, extracting an electronic shelf label on the path based on position information indicating a position of each electronic shelf label in the facility, and controlling an output of the extracted electronic shelf label.

A program according to an aspect of the present disclosure causes a computer to execute a process of specifying a position of a target person in a facility, specifying a path from the specified position to a position of a target item, extracting an electronic shelf label on the path based on position information indicating a position of each electronic shelf label in the facility, and controlling an output of the extracted electronic shelf label.

The program may be stored in a non-transitory computer-readable recording medium.

### Advantageous Effects of Invention

According to the present disclosure, it is possible to facilitate guidance to an item in a facility.

### BRIEF DESCRIPTION OF DRAWINGS

FIG. 1 is a block diagram illustrating a configuration example of a control system according to a first example embodiment.

FIG. 2 is a flowchart illustrating an operation example of the control system according to the first example embodiment.

FIG. 3 is an explanatory diagram illustrating an example of a store viewed from above.

FIG. 4 is an explanatory diagram illustrating an example of connection between a control system according to a second example embodiment and other devices.

FIG. 5 is an explanatory diagram illustrating an example of an electronic shelf label.

FIG. 6 is a block diagram illustrating a configuration example of the control system according to the second example embodiment.

FIG. 7 is an explanatory diagram illustrating an example of a path from a position of a customer to a position of a target product.

FIG. 8 is an explanatory diagram illustrating an example in which an LED included in an electronic shelf label is turned on.

FIG. 9 is an explanatory diagram illustrating a first example in which a symbol indicating a traveling direction is displayed on a display device of an electronic shelf label.

FIG. 10 is an explanatory diagram illustrating a second example in which a symbol indicating a traveling direction is displayed on a display device of an electronic shelf label.

FIG. 11 is an explanatory diagram illustrating an example in which an extracted electronic shelf label is controlled.

FIG. 12 is an explanatory diagram illustrating a new path and an example in which outputs of electronic shelf labels on the path are controlled.

FIG. 13 is an explanatory diagram illustrating a first example of controlling an output of an electronic shelf label within a predetermined distance.

FIG. 14 is an explanatory diagram illustrating a second example of controlling an output of an electronic shelf label within a predetermined distance.

FIG. 15 is a flowchart illustrating an operation example of the control system according to the second example embodiment.

FIG. 16 is an explanatory diagram illustrating a hardware configuration example of a computer device.

### EXAMPLE EMBODIMENT

Hereinafter, example embodiments of a control system, a control method, a program, and a non-transitory recording medium having a program recorded therein according to the present disclosure will be described in detail with reference to the drawings. The present example embodiments are not intended to limit the technology of the disclosure.

In each example embodiment, it is assumed that a position of an electronic shelf label is specified in advance, and position information of the electronic shelf label is stored in advance in a storage unit or the like. The position information of the electronic shelf label may be, for example, a coordinate value in a facility or information indicating a shelf on which the electronic shelf label is installed or a position on the shelf, and an expression format of the position information is not particularly limited. For example, the electronic shelf label may have a function which allows the control system to specify the position information. For example, the electronic shelf label has a function that allows the control system to specify the position information of the electronic shelf label by infrared communication with a communication device installed in a store or wireless communication such as Bluetooth (registered trademark) Low Energy (BLE).

### First Example Embodiment

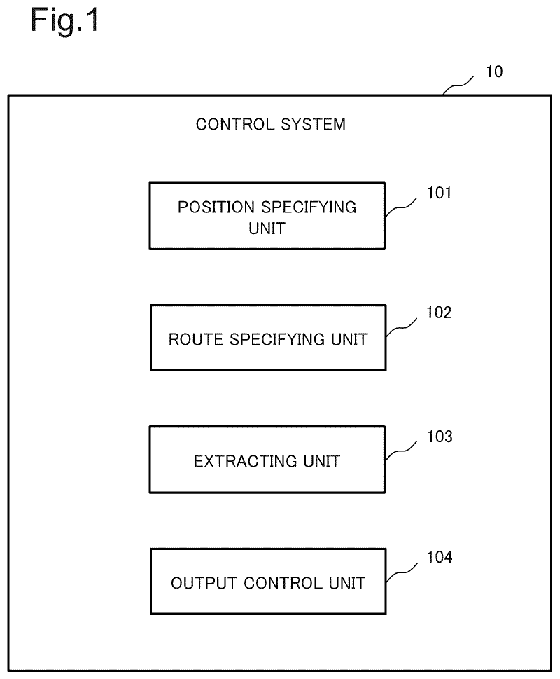

First, in the first example embodiment, basic functions of the control system will be described. FIG. 1 is a block diagram illustrating a configuration example of a control system according to a first example embodiment. A control system 10 controls outputs of electronic shelf labels. For example, the control system 10 includes a position specifying unit 101, a path specifying unit 102, an extracting unit 103, and an output control unit 104.

The position specifying unit 101 specifies a position of a target person in a facility. The facility is not particularly limited to outdoors, indoors, or the like and includes, for example, a store, a factory, a warehouse, or the like. The target person may vary depending on the facility. In a case in which the facility is a store, the target person is a customer, a store clerk, or the like. In a case in which the facility is a factory or a warehouse, the target person is a worker or the like.

Specifically, for example, the position specifying unit 101 may specify a position of a terminal device held by the target person as the position of the target person in the facility. A method for specifying the position of the terminal device is not particularly limited. The position specifying unit 101 may locate the terminal device by performing near field communication between a fixed device fixedly arranged in a facility and the terminal device. An expression format of position information indicating the position of the target person is not particularly limited, similarly to the position information of the electronic shelf label.

Alternatively, for example, the position specifying unit 101 may extract the target person from an image captured by an imaging device installed in the store and specify the position of the target person based on the position of the target person in the image and layout information of the store by.

The path specifying unit 102 specifies a path from the position of the target person to a position of a target item. The target item may be, for example, an item designated by the target person or an item decided in advance by the facility. The position of the target item may be, for example, the position of the electronic shelf label that displays item information indicating the target item. In the following description, the electronic shelf label that displays the item information indicating the item is also referred to as an electronic shelf label associated with the item. Therefore, for example, the path specifying unit 102 may specify a path from the position of the target person to the position of the target item based on the position information of the electronic shelf label, the position information of the target person, and the layout information of the facility.

The extracting unit 103 extracts the electronic shelf label on the path based on the position information of each electronic shelf label in the facility.

The output control unit 104 controls an output of the extracted electronic shelf label. For example, the output control unit 104 controls an output for guiding a path. A detailed display example by the output control unit 104 will be described in the second example embodiment.

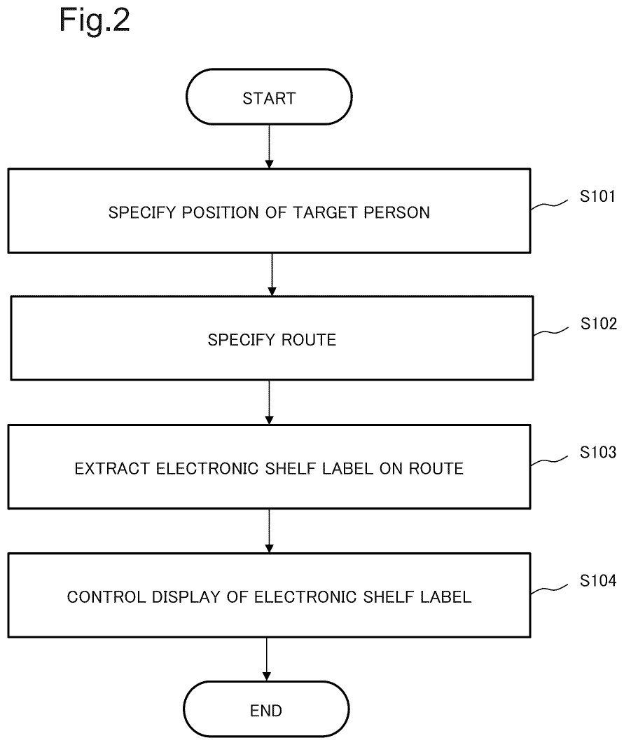

FIG. 2 is a flowchart illustrating an operation example of the control system 10 according to the first example embodiment. The position specifying unit 101 specifies the position of the target person (step S101).

The path specifying unit 102 specifies the path from the position of the target person to the position of the target item (step S102). In step S102, the path specifying unit 102 specifies the path based on the position information of the electronic shelf label, the position information of the target person, and the layout information of the facility.

The extracting unit 103 extracts the electronic shelf label on the path based on the position information of each electronic shelf label (step S103). The output control unit 104 controls the output of the electronic shelf label (step S104).

Then, the control system 10 ends the process after step S104. Although not illustrated, the control system 10 may return to step S101 after step S104. Accordingly, the control system 10 repeats the process from step S101 to step S104 until the target person arrives at the target item, and thus the path can be continuously guided even through the target person moves.

As described above, in the first example embodiment, the control system 10 specifies the position of the target person in the facility, specifies the path from the specified position to the position of the target item, extracts the electronic shelf label on the path, and controls the output of the extracted electronic shelf label. Accordingly, the target person can check the path to the target item with the electronic shelf label without looking at a paper map, a map displayed on the fixedly arranged device, or a map displayed on a smartphone. Therefore, it is possible to facilitate guidance to the item in the facility.

For example, in a case in which the facility is a store, the customer may ask a store clerk or the like when the customer does not know the path to the product. According to the control system 10 according to the first example embodiment, since the customer can check the path to the target item with the electronic shelf label, it is possible to save the effort of the store clerk.

The first example embodiment is not limited to the example described above, and various modifications can be made.

### Second Example Embodiment

Next, a second example embodiment will be described in detail with reference to the drawings. In the second example embodiment, an example of controlling the output of the electronic shelf label in more detail will be described with an example in which the facility is the store, the target person is the customer, and the target item is a target product. The second example embodiment will be described with an example in which the position of the terminal device is specified as the position of the target person using near field communication. Hereinafter, description of contents overlapping with the above description will be omitted to the extent that the description of the second example embodiment is not unclear.

The store may be, for example, a store such as a supermarket, a supermarket center, a convenience store, a mass retailer, a home center, a drug store, a store that handles apparel products, or an individual store such as a bakery or a daily dish store, and is not particularly limited.

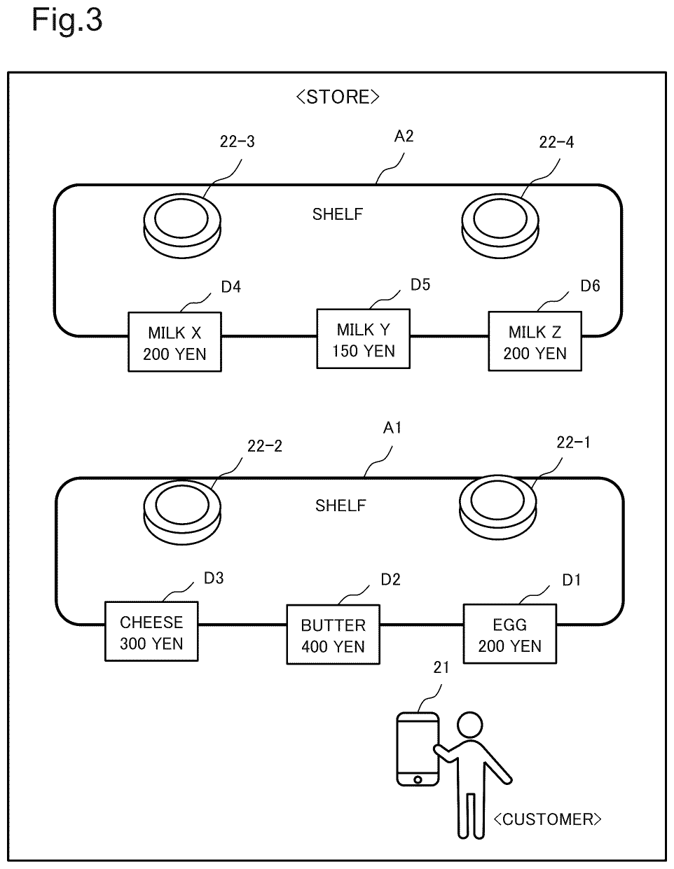

FIG. 3 is an explanatory diagram illustrating an example of the store viewed from above. For example, a plurality of shelves A are installed in the store. The number of shelves A is not limited to that in the example of FIG. 3. Products are displayed on each of a plurality of shelves A. Then, an electronic shelf label D is installed for each product displayed on the shelf A.

In the example of FIG. 3, a shelf A1 and a shelf A2 are provided. Cheese, butter, and eggs are displayed on the shelf A1. Therefore, an electronic shelf label D3 displaying display product information of cheese, an electronic shelf label D2 displaying display product information of butter, and an electronic shelf label D1 displaying display product information of egg are provided on the shelf A1. Milk X, milk Y, and milk Z are displayed on the shelf A2. Therefore, electronic shelf labels D4 to D6 displaying the display product information of the milk X, the milk Y, and the milk Z are provided on the shelf A2. The electronic shelf label D is installed near a display position of a product indicated by the product information being displayed. The display product information is product information indicating each product, and is information to be displayed on the electronic shelf label D.

The terminal device 21 is a portable device. The terminal device 21 is a device operable by the customer. The terminal device 21 may be a device lent from the store to the customer or may be a device of the customer. The type of the terminal device 21 is not particularly limited, and examples thereof include a smartphone and a tablet device. A specific application program provided by the store in advance may be installed in the terminal device 21 in advance. For example, the control system 20 may output various types of information to the terminal device 21 through the specific application program.

In FIG. 3, a plurality of devices 22-1 to 22-4 are communication devices used to specify the position of the terminal device 21. Here, in a case in which the device is not particularly limited, the device is simply referred to as a device 22. In the example of FIG. 3, the number of devices 22 is four, but is not particularly limited. The device 22 is fixedly arranged. For example, a plurality of devices 22 are dispersedly arranged at different positions in the store (facility). The device 22 is arranged on a ceiling, a floor, a shelf, or the like of the store. For example, in a case in which the device 22 is a transmitter that transmits a radio wave, the terminal device 21 is a receiver that receives the radio wave. On the other hand, in a case in which the device 22 is a receiver that receives a radio wave, the terminal device 21 is a transmitter that transmits the radio wave. The device 22 is, for example, a beacon device or the like. For example, the position of the terminal device 21 is estimated based on the reception strength of the radio wave which is transmitted and received between the device 22 and the terminal device 21.

The device 22 may have a function capable of communicating with the electronic shelf label D. For example, the device 22 communicates with the electronic shelf label D via wireless communication such as BLE or infrared communication. Accordingly, the position of the electronic shelf label D can be specified, and the output of the electronic shelf label D can be controlled. In order to simplify the description, an example in which the device 22 has both functions of the device used to specify the position of the terminal device 21 and the device for controlling the display content of the electronic shelf label D will be described, but the devices may be different from each other. For example, the devices may be different from each other, such as the device that performs infrared communication with the electronic shelf label D and the device capable of performing radio wave-based near field communication with the terminal device 21. In the following description, the infrared communication will be described as an example of the communication between the device 22 and the electronic shelf label D.

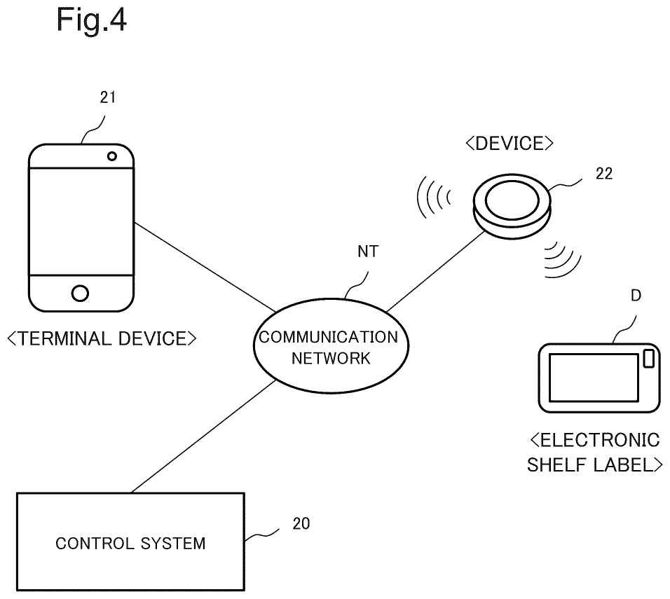

FIG. 4 is an explanatory diagram illustrating an example of connection between the control system according to the second example embodiment and other devices. The control system 20 is connected to the terminal device 21 via a communication network NT. The control system 20 is connected to the terminal device 21, the device 22, and the like via a communication network. The control system 20 controls the output of the electronic shelf label D through the device 22. Specifically, the control system 20 transmits information for control to the device 22, and the device 22 transmits the information for control to the electronic shelf label D via infrared communication.

In the second example embodiment, for the sake of ease of description, one terminal device 21 will be described as an example, but the control system 20 may be connected to a plurality of terminal devices 21. The device 22 has a function of performing near field communication with the terminal device 21. The device 22 has a function of capable of communicating with the electronic shelf label D via infrared rays.

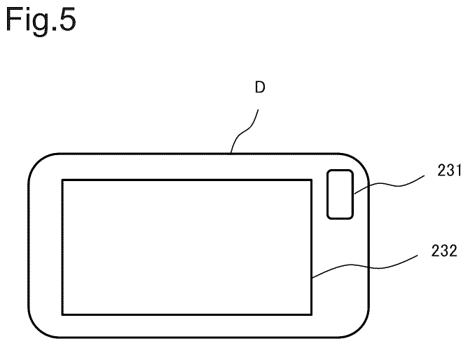

n is an integer of 1 or more, and the number of electronic shelf labels D is not particularly limited. The electronic shelf label D will be described with reference to FIG. 5.

FIG. 5 is an explanatory diagram illustrating an example of the electronic shelf label D. The electronic shelf label D includes, for example, an LED 231 and a display device 232. The LED 231 is an example of a lighting device, and the type of the lighting device is not particularly limited. The display device 232 may be an electronic paper or a liquid crystal display (LCD). The LED 231 and the display device 232 are disposed on the front surface or the like of the electronic shelf label D. Although not illustrated, a hook or the like is disposed on the back surface of the electronic shelf label D, and the electronic shelf label D is installed on the shelf A by the hook.

Although not illustrated, the electronic shelf label D has a function capable of performing infrared communication with the device 22 or the terminal device 21.

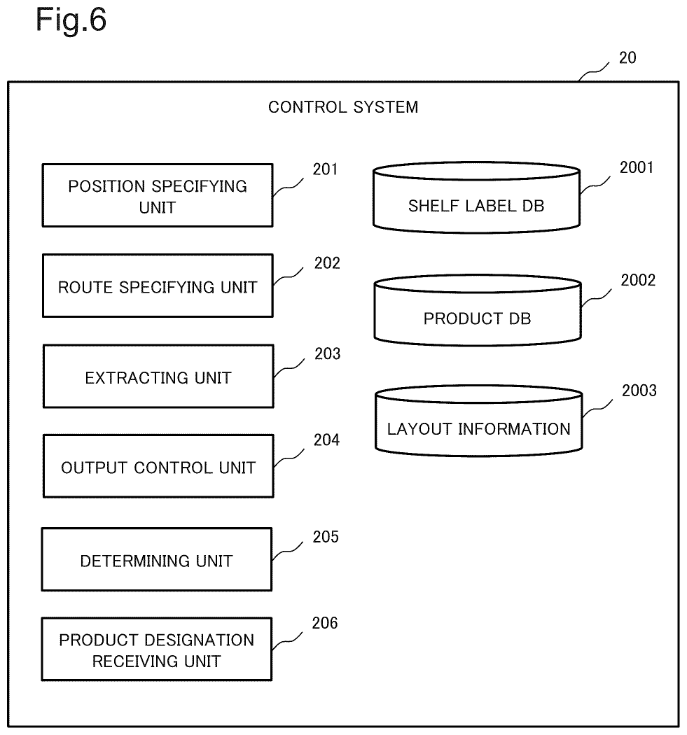

FIG. 6 is a block diagram illustrating a configuration example of the control system 20 according to the second example embodiment. The control system 20 includes a position specifying unit 201, a path specifying unit 202, an extracting unit 203, an output control unit 204, a determining unit 205, and a product designation receiving unit 206. The control system 20 according to the second example embodiment is different from the control system 20 according to the first example embodiment in that the determining unit 205 and the product designation receiving unit 206 are newly added. The position specifying unit 201, the path specifying unit 202, the extracting unit 203, and the output control unit 204 have the basic functions of the position specifying unit 101, the path specifying unit 102, the extracting unit 103, and the output control unit 104 in the first example embodiment, respectively.

The control system 20 includes a shelf label database (DB) 2001, a product DB 2002, and layout information 2003. The layout information 2003 is the layout information 2003 of the store. For example, the layout information 2003 is information indicating the map of the store.

The shelf label DB 2001 stores shelf label identification information, position information, product identification information, and the like in association with each shelf label. The product DB 2002 stores the product identification information, the display product information, and the like in association with each product. The shelf label identification information is not particularly limited as long as the electronic shelf label D can be identified. The product identification information is not particularly limited as long as the product can be identified. For example, in the shelf label DB 2001, the product identification information is identification information of the product for which the display product information is displayed on the shelf label indicated by the shelf label identification information. In the product DB 2002, the display product information is information related to the product to be displayed on the electronic shelf label D. The display product information is, for example, information such as a price of the product, a product name, and a stock, and is not particularly limited.

For example, the output control unit 204 acquires the display product information from the shelf label DB 2001 and the product DB 2002, and displays the acquired displayed product information on the display device 232 of the electronic shelf label D.

First, the position specifying unit 201 specifies the position of the customer in the store. The position specifying unit 201 may continuously specify the position of the customer. Specifically, for example, the position specifying unit 201 specifies the position of the terminal device 21 of the customer as the position of the terminal device 21 of the customer. More specifically, for example, the position specifying unit 201 locates the terminal device 21 by near field communication between the terminal device 21 of the customer and the device 22.

A timing at which the position specifying unit 201 specifies the position of the target person is not particularly limited. In a case in which the position specifying unit 201 specifies the position of the customer for the first time, this timing may be a timing designated by the target person.

In a case in which the position specifying unit 201 continuously specifies the position of the customer, this timing may be a timing designated by the target person. Alternatively, this timing may be a periodic timing such as predetermined time intervals. That is, for example, this timing is a timing at which a predetermined time has elapsed since the path was specified last time. Alternatively, in a case in which the terminal device 21 includes an acceleration sensor, this timing may be a timing at which a moving distance calculated based on acceleration detected by the acceleration sensor is determined a certain distance or more, such as. That is, in a case in which the customer has moved by a certain distance or more, the position specifying unit 201 newly specifies the position of the target person.

The path specifying unit 202 specifies the path from the position of the customer to the position of the target product. A method of selecting a product set as the target product among a plurality of products in a store will be described later. As illustrated in FIG. 3, each product includes the electronic shelf label D on which the display product information of the product is displayed. Therefore, the position of the electronic shelf label D associated with the target product may be used as the position of the target product. Specifically, for example, the path specifying unit 202 specifies the path from the position of the customer to the position of the electronic shelf label D associated with the target product based on the position information of the electronic shelf label D associated with the target product, the position information of the customer, and the layout information 2003. The path specifying unit 202 can specify the path along the layout of the store, rather than the linear path from the position of the electronic shelf label D associated with the target product to the position of the customer, by using the layout information 2003. The electronic shelf label D associated with the target item may or may not be extracted as the electronic shelf label D on the path. In the following description, the electronic shelf label D associated with the target item is distinguished from the electronic shelf label D on the path. The path specifying unit 202 may continuously specify the path. Alternatively, this timing may be a timing at which the position of the customer is specified by the position specifying unit 201.

The timing at which the path specifying unit 202 specifies the path is not particularly limited. In a case in which the path specifying unit 202 specifies the path for the first time, this timing may be a timing designated by the customer.

In a case in which the path specifying unit 202 continuously specifies the path, this timing may be a timing designated by the customer. Alternatively, this timing may be a periodic timing such as predetermined time intervals. That is, this timing is a timing at which a predetermined time has elapsed since the path was specified. Alternatively, this timing may be a timing at which the position of the customer is newly specified by the position specifying unit 201. Alternatively, this timing may be a case in which the position of the customer newly specified by the position specifying unit 201 is apart from the previously specified position by a predetermined distance or more. Accordingly, it is possible to prevent the output of the electronic shelf label D from being controlled many times.

A plurality of target products may be provided, and in a case in which there are a plurality of target products, the path specifying unit 202 specifies the path running through all of a plurality of target products from the position of the customer.

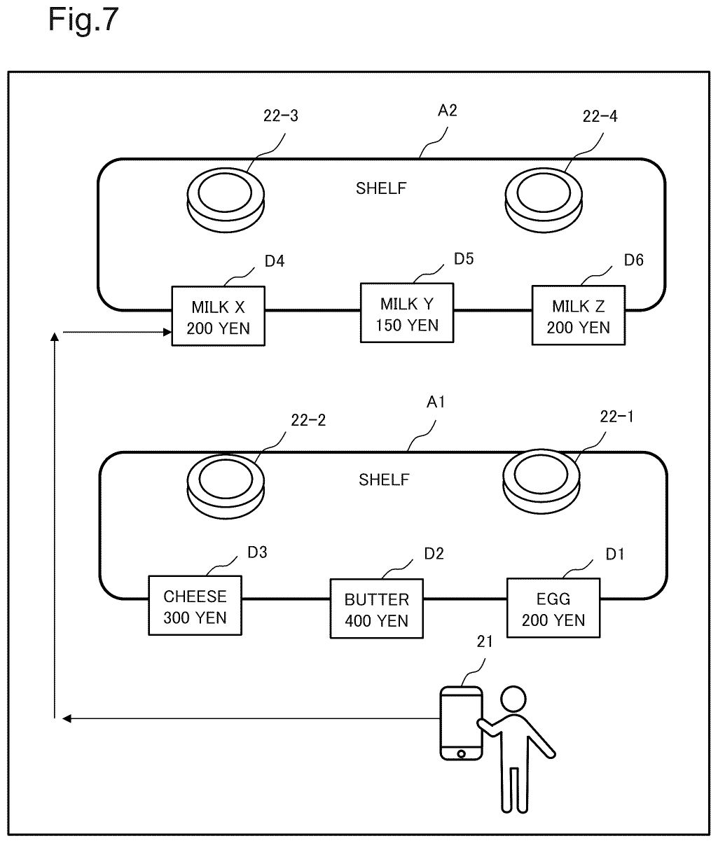

FIG. 7 is an explanatory diagram illustrating an example of the path from the position of the customer to the position of the target product. In FIG. 7, the customer is near the butter or the egg on the shelf A1. In FIG. 7, the target product is the milk X. In FIG. 7, the path from the position of the terminal device 21 to the position of the electronic shelf label D of the milk X is specified.

Referring back to the description of FIG. 6, the extracting unit 203 extracts the electronic shelf label D on the path based on the position information of each electronic shelf label D in the store. The electronic shelf label D on the path refers to the electronic shelf label D associated with the product at a position in which the product can be acquired when the customer passes through the path. In the example of FIG. 7, the electronic shelf labels D respectively associated with the egg, the butter, and the cheese are extracted.

Next, the output control unit 204 controls the output of the extracted electronic shelf label D. For example, the output control unit 104 controls the output for guiding the path as described above. As described above, the output control unit 204 controls the output of the electronic shelf label D via infrared communication by the device 22. For example, the output control unit 204 controls at least one of the display device 232 of the extracted electronic shelf label D and the LED 231.

Specifically, for example, the output control unit 204 may control the output of the extracted electronic shelf label D in such a way that the path can be identified. For example, the output control unit 204 transmits information for control to the extracted electronic shelf label D via the device 22. For example, the output control unit 204 may control the output of the extracted electronic shelf label D in such a way that the path can be identified for a certain period of time. For example, the information for control transmitted from the output control unit 204 to the electronic shelf label D may include information indicating a certain period of time. The certain period of time may be a period of time decided in advance or a period of time specified by the customer.

As the control, the output control unit 204 may control turning-on or off of the LED 231 of the electronic shelf label D. As the control, the output control unit 204 may perform control on display content to be displayed on the display device 232 of the electronic shelf label D.

### <Control of LED 231>

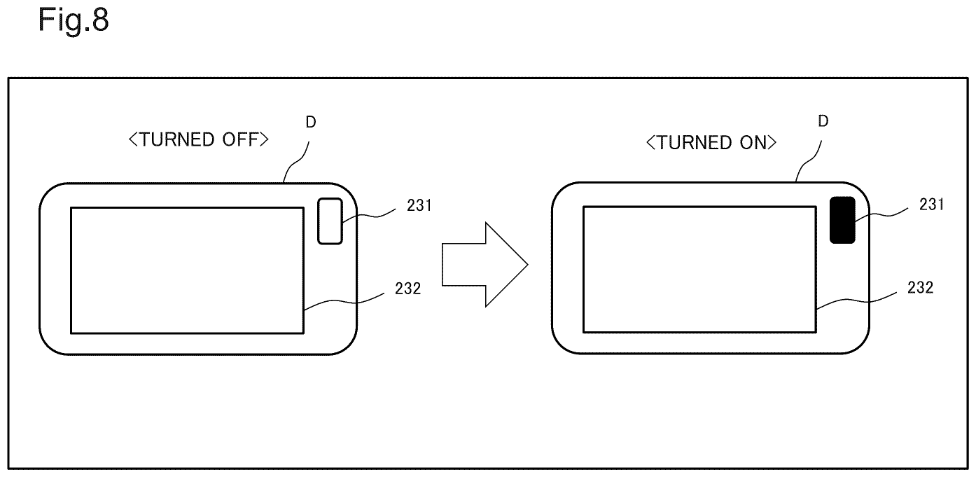

First, an example of controlling the turning on or off of the LED 231 will be described with reference to FIG. 8. FIG. 8 is an explanatory diagram illustrating an example in which the LED 231 included in the electronic shelf label D is turned on. Specifically, for example, the output control unit 204 may turn on the lighting device included in the extracted electronic shelf label D. Accordingly, the customer can find the path by tracking the electronic shelf label D being turned on.

Although not illustrated, for example, the output control unit 204 may set a color indicating the path as a display color of the LED 231 included in the extracted electronic shelf label D. The color indicating the path may be decided in advance or may be designated by the customer. Accordingly, the customer can find the path by tracking the electronic shelf label D being lit in the color indicating the path. For example, the output control unit 204 may set the color indicating the path as the display color of the extracted electronic shelf label D. The output control unit 204 may display at least one of a symbol and text indicating the path on the extracted electronic shelf label D.

### <Control of Display Content of Display Device 232>

Next, an example of controlling the display content to be displayed on the display device 232 of the electronic shelf label D will be described. Specifically, for example, the output control unit 204 may cause the display device 232 included in the extracted electronic shelf label D to display the color indicating the path.

For example, the output control unit 204 may display at least one of a symbol and text indicating the path on the display device 232 of the extracted electronic shelf label D. At least one of the symbol and the text indicating the path may represent the traveling direction of the path. Specifically, for example, the output control unit 204 may control the output of the display device of 232 of the extracted electronic shelf label D in such a way that the traveling direction along the path can be identified. More specifically, for example, the output control unit 204 may display at least one of a symbol and text indicating the traveling direction along the path on the display device 232 of the extracted electronic shelf label D. For example, the symbol indicating the traveling direction along the path may be an arrow, an instruction mark, or the like. For example, the text indicating the traveling direction along the path may be an instruction such as “go straight” or “turn”.

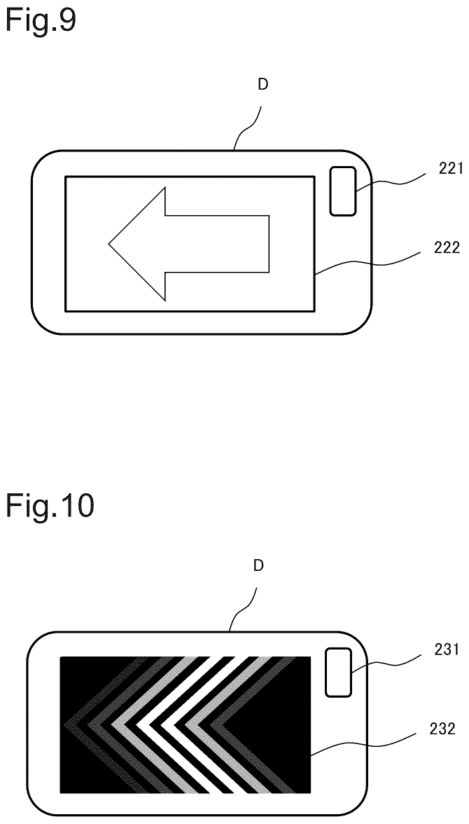

FIG. 9 is an explanatory diagram illustrating a first example in which the symbol indicating the traveling direction is displayed on the display device 232 of the electronic shelf label D. In FIG. 9, the arrow indicating the traveling direction is displayed on the display device 232 of the electronic shelf label D. Accordingly, the customer understands the path to the target product and the traveling direction along the path.

FIG. 10 is an explanatory diagram illustrating a second example in which the symbol indicating the traveling direction is displayed on the display device 232 of the electronic shelf label D. In FIG. 10, in a case in which the display device 232 of the electronic shelf label D is an LCD or the like, a plurality of images including the arrow indicating the traveling direction may be displayed on the display device 232 in a slideshow-like manner, similarly to a single moving image. The slideshow-like display may be repeated. Accordingly, the customer understands the path to the target product and the traveling direction along the path.

For example, when the distance to the target product in the path is long, the customer may understand a rough direction. On the other hand, when the distance to the target product in the path is short, the customer may understand a more detailed path to the target product. Therefore, in a case in which at least one of the symbol and the text is displayed, the output control unit 204 may display at least one of a symbol and text which is associated with the distance between the target product and the extracted electronic shelf label D. For example, the output control unit 204 may display an arrow indicating the traveling direction on the electronic shelf label D from which the distance to the target product on the path is long, and may display a detailed instruction for the path on the electronic shelf label D from which the distance to the target product on the path is short.

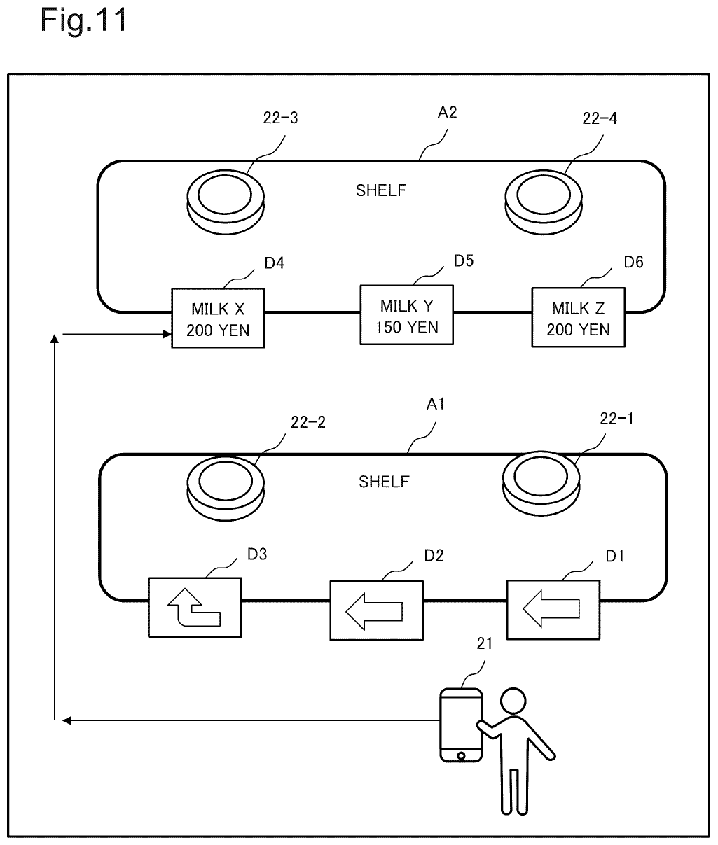

FIG. 11 is an explanatory diagram illustrating an example in which the extracted electronic shelf label D is controlled. Here, it is assumed that the electronic shelf label D1, the electronic shelf label D2, and the electronic shelf label D3 are extracted as the electronic shelf label D on the path. The output control unit 204 displays the arrow indicating the traveling direction on each of the display devices 232 of the electronic shelf label D1, the electronic shelf label D2, and the electronic shelf label D3. For example, the symbol indicating the turning direction or the like may be displayed on the display device 232 of the electronic shelf label D at the corner of the passage like the electronic shelf label D3. Accordingly, the customer may proceed along the arrows displayed on the electronic shelf label D1, the electronic shelf label D2, and the electronic shelf label D3.

Although not illustrated, the output control unit 204 may display text such as “turn right” or “turn left” on the display device 232 of the electronic shelf label D at the corner of the passage like the electronic shelf label D3.

Referring back to the description of FIG. 6, the output control unit 204 may control the output of the electronic shelf label D associated with the target product in such a way that the presence of the target product can be identified. For example, the output control unit 204 may control the output of the electronic shelf label D in such a way that the electronic shelf label D associated with the target product and the electronic shelf label D on the path have different modes. More specifically, for example, the output control unit 204 may display the symbol or the text indicating the traveling direction along the path on the display device 232 of the electronic shelf label D on the path, and cause the light source of the electronic shelf label D associated with the target product to be turned on.

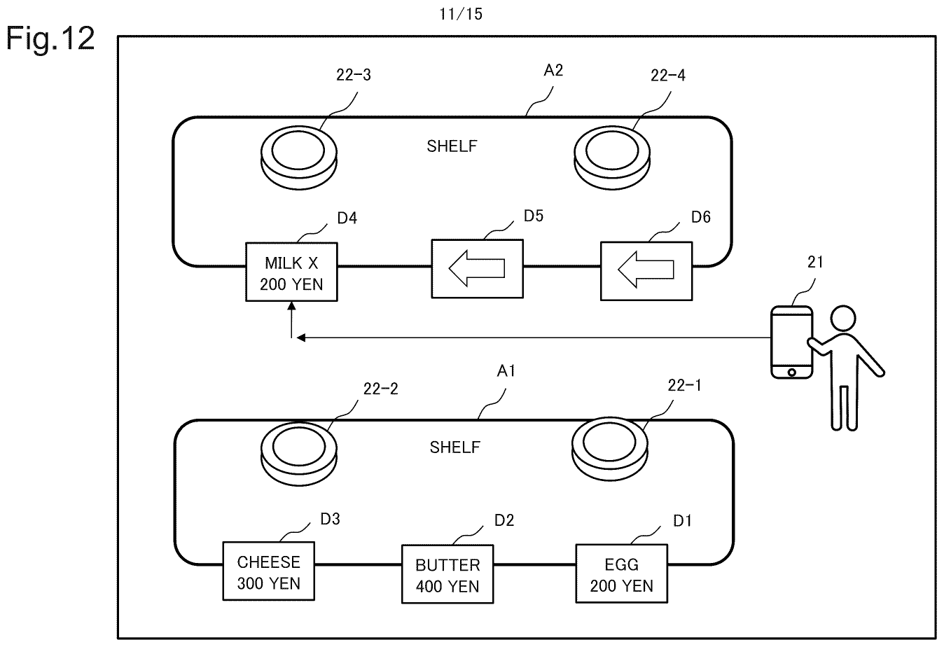

FIG. 12 is an explanatory diagram illustrating a new path and an example in which the outputs of the electronic shelf labels D on the path are controlled. Even through the path is output on the electronic shelf label D, the customer may not proceed along the path. In FIG. 12, the customer near the egg or the butter in FIG. 11 is moving toward the milk Z. Even in this case, the position specifying unit 201 newly specifies the position of the customer. Then, the path specifying unit 202 specifies a new path from the newly specified position of the customer to the position of the target product. Then, the extracting unit 203 extracts an electronic shelf label D5 and an electronic shelf label D6 on the path. The output control unit 204 displays the symbol indicating the traveling direction along the path on the display device 232 of the electronic shelf label D5 and the display device 232 of the electronic shelf label D6. Accordingly, the display device 232 of the electronic shelf label D5 and the display device 232 of the electronic shelf label D6 display the symbol indicating the traveling direction along the path.

As described above, even when the customer unexpectedly moves without moving along the path, the new path is specified, and the guidance is continued.

The output control unit 204 displays the display product information associated with the electronic shelf label D on the electronic shelf label D which is on the path specified immediately before but is not on the path specified newly. Here, immediately before refers to the path specified immediately before the new path is specified. Accordingly, for example, in a case in which a symbol is being displayed on the display device 232 of the electronic shelf label D, the display can be returned to the original display product information. For example, in FIG. 11, the display device 232 of each of the electronic shelf label D1, the electronic shelf label D2, and the electronic shelf label D3 display the symbol indicating the traveling direction. Then, in FIG. 12, since the electronic shelf label D1, the electronic shelf label D2, and the electronic shelf label D3 are not extracted due to the movement of the customer, the electronic shelf label D1, the electronic shelf label D2, and the electronic shelf label D3 display the display product information of each product.

The determining unit 205 may determine whether the customer has arrived at the target product based on the newly specified position information of the customer and the position information of the target product. Here, the customer's arrival at the target product means that the customer has arrived near the target product. More specifically, the customer's arrival at the target product means that the customer is within a predetermined distance from the position indicated by the position information of the target product. In more detail, for example, the customer's arrival at the target product means that the position of the terminal device of the customer is within a predetermined distance from the position of the electronic shelf label D associated with the target product. The determining unit 205 may make a determination when the path specifying unit 202 specifies the path. In a case in which the target person has not arrived at the target item, the extracting unit 203 extracts the electronic shelf label D on the path. On the other hand, in a case in which the customer has arrived at the target product, the extracting unit 203 does not newly extract the electronic shelf label D on the path. Then, the output control unit 204 displays information identifying the position of the target item on the electronic shelf label D associated with the target item. The output control unit 204 displays the item information, which indicates the item associated with the electronic shelf label D on the path specified immediately before. Accordingly, the display of the electronic shelf label D returns to its original state.

### <Example of Controlling Output of Some of Electronic Shelf Labels D on Path>

In the example of FIG. 11, the example in which all the outputs of the electronic shelf labels D on the path are controlled has been described, but the present disclosure is not limited thereto, and the outputs of some of the electronic shelf labels D on the path may be controlled.

Specifically, for example, the extracting unit 203 may extract some of the electronic shelf labels D on the path. Then, the output control unit 204 may control the outputs of some of the extracted electronic shelf labels D. The electronic shelf labels D to be extracted among the electronic shelf labels D on the path are not particularly limited. The extracting unit 203 may alternately extract the electronic shelf labels D in the traveling direction among the electronic shelf labels D on the path. Alternatively, for example, the extracting unit 203 may extract a predetermined number of electronic shelf labels D among the electronic shelf labels D on the path. The predetermined number may be decided in advance or may be designated by the customer.

For example, in a case in which there are a large number of electronic shelf labels D on the path, narrowing down to some electronic shelf labels D may make it easier for the customer easily understand. For example, there are cases in which a plurality of electronic shelf labels D is installed on the shelf A at substantially the same position in the horizontal and vertical directions but at different positions in the height direction. In this case, the extracting unit 203 may extract some electronic shelf labels D from a plurality of electronic shelf labels D which are at substantially the same position in the horizontal and vertical directions on the path and at different positions in the height direction. For example, the number of some electronic shelf labels D is not limited. For example, some of the electronic shelf labels D may be electronic shelf labels D installed at heights that are easy for customers to see.

There are cases in which, among the electronic shelf label D on the path, the customer check nearby electronic shelf labels D but does not check electronic shelf labels D which are farther away. There are cases in which other customers obstruct the checking of the display content of the electronic shelf label D. Therefore, the extracting unit 203 extracts the electronic shelf labels D within a predetermined distance from the position of the customer among the electronic shelf labels D on the path. The predetermined distance may be a distance decided in advance or a distance designated by the customer. The output control unit 204 controls the outputs of the electronic shelf labels D on the path within a predetermined distance from the position of the customer. In a case in which the customer is near the target product, all the electronic shelf labels D on the path may be the electronic shelf labels D within a predetermined distance from the position of the customer.

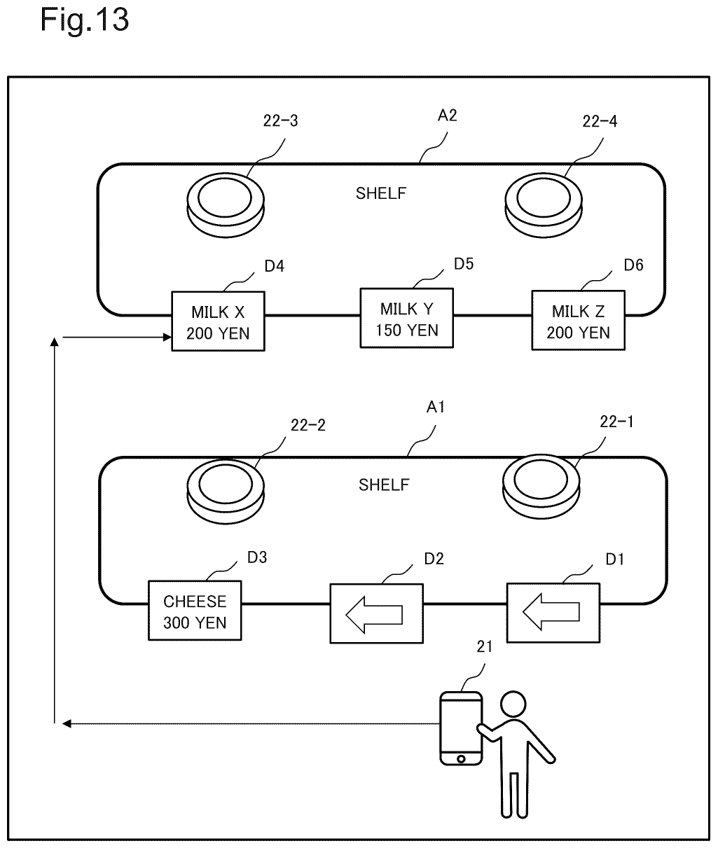

FIG. 13 is an explanatory diagram illustrating a first example of controlling the outputs of the electronic shelf labels D within a predetermined distance. In FIG. 13, the extracting unit 203 extracts the electronic shelf label D1 and the electronic shelf label D2 that are within a predetermined distance from the position of the customer (for example, the position of the terminal device 21) from among the electronic shelf label D1, the electronic shelf label D2, and the electronic shelf label D3 on the path. Then, in FIG. 13, the output control unit 204 displays the symbol indicating the traveling direction on the display device 232 of the electronic shelf label D1 and the display device 232 of the electronic shelf label D2.

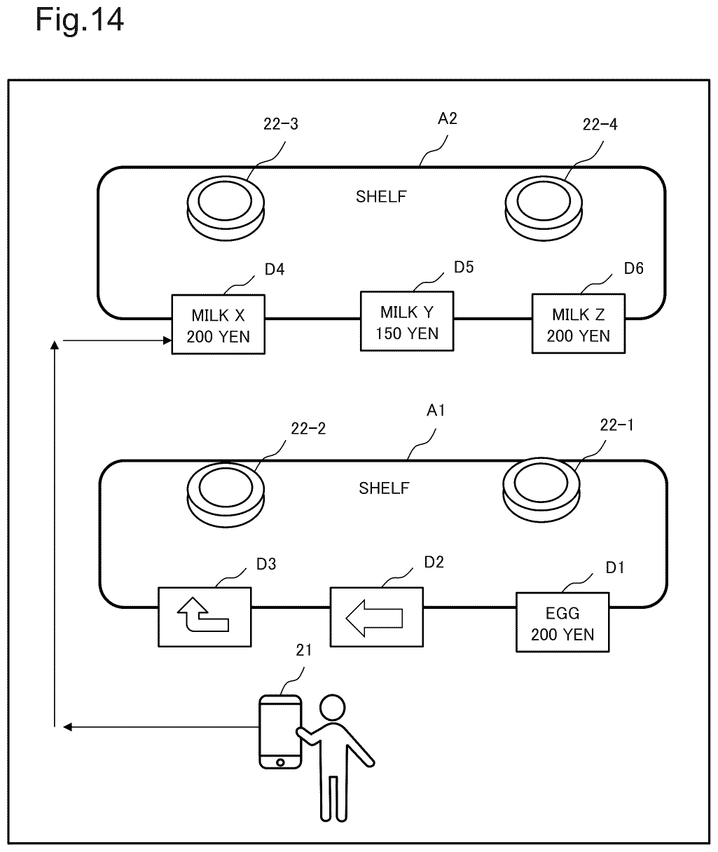

FIG. 14 is an explanatory diagram illustrating a second example of controlling the outputs of the electronic shelf labels D within a predetermined distance. In FIGS. 13 to 14, the customer is moving in the traveling direction. Here, it is assumed that a position of a new customer is specified and the path is newly specified as illustrated in FIG. 14. In FIG. 14, the extracting unit 203 extracts the electronic shelf label D2 and the electronic shelf label D3 that are within a predetermined distance from the position of the customer (for example, the position of the terminal device 21) out of the electronic shelf label D2 and the electronic shelf label D3 on the path. In FIG. 14, the output control unit 204 displays the symbol indicating the traveling direction on the display device 232 of the electronic shelf label D2 and the display device 232 of the electronic shelf label D3.

### <Example of Specifying Path>

There are cases in which there are a plurality of paths from the position of the customer to the position of the target product. In this case, the path specifying unit 202 may specify any one path among a plurality of paths from the position of the customer to the position of the target product. For example, the path specifying unit 202 may specify the shortest path among a plurality of paths. Accordingly, the customer can find the target product in a shorter time by tracing the electronic shelf label D whose output is controlled.

There are cases in which the store provides special sale products or the like. Therefore, the path specifying unit 202 may specify a path running through a specific item (here, a specific product) from the position of the customer to the position of the target product. The specific product is not limited to a special sale product. Accordingly, in the store, it is possible to guide the customer to the special sale product. The output control unit 204 may output, for the specific product, information indicating the specific product to the electronic shelf label D associated with the specific product. For example, the output control unit 204 may display the symbol indicating the path and the information indicating the specific product on the display device 232 of the electronic shelf label D associated with the specific product alternately at predetermined intervals. The predetermined interval is not particularly limited, and may be designated in advance.

### <Example of Designating Target Product>

Next, a method of selecting the product set as the target product among a plurality of products in a store will be described. The target product may be designated by the customer or may be decided by the store. The product decided by the store may be, for example, a special sale product. The target product may be a product included in a shopping list created by the customer in advance. The shopping list is a list including product identification information identifying products which the customer is going to purchase. Here, the products indicated by the product identification information included in the shopping list are also referred to, in abbreviated form, as products included in the shopping list. The timing at which the customer creates the shopping list is not particularly limited. As described above, there may be a plurality of target products.

Here, an example in which the target product is designated by the customer will be described. The product designation receiving unit 206 receives designation of the target product according to the customer's operation on the terminal device 21. Specifically, the terminal device 21 receives the designation of the target product according to the customer's operation. Then, the terminal device 21 transmits the product identification information identifying the received target product to the control system 20. Here, as the process of receiving the designation of the target product, for example, the terminal device 21 may receive selection of any one image from images of the products according to the customer's operation via a specific application program. As another process of receiving the designation of the target product, for example, the terminal device 21 may receive the product identification information such as the product name according to the customer's operation via a specific application program. As another process of receiving the designation of the target product, for example, the terminal device 21 may receive search for the product according to the customer's operation via a specific application program and receive the searched product as the target product.

Then, the product designation receiving unit 206 receives receive the designation of the target product by receiving the product identification information. The product designation receiving unit 206 is not limited to the example of receiving the designation of the target product, and may receive designation of the type of product. Then, the product classified into the designated type is the target product. For example, in this case, the product identification information, the display product information, the classification information, and the like may be stored in the product DB 2002 in association with each product. Then, the product designation receiving unit 206 specifies the product associated with the designated type with reference to the product DB 2002. When the product designation receiving unit 206 newly receives the target product, the position specifying unit 201 may specify the position of the target person.

Next, an example in which the target product is the product included in the shopping list will be described. For example, the product designation receiving unit 206 may receive the designation of the product from the products included in the shopping list according to the customer's operation on the terminal device 21.

Since there may be a plurality of target products, the product designation receiving unit 206 may receive designation of a plurality of target products from a plurality of products included in the shopping list. All of a plurality of products included in the shopping list may be set as the target products. For example, in a case in which all of a plurality of products included in the shopping list are set as the target products, the path specifying unit 202 specifies the path running through all the products included in the shopping list from the position of the customer. As described above, the position of each product is the position of the electronic shelf label D associated with the product.

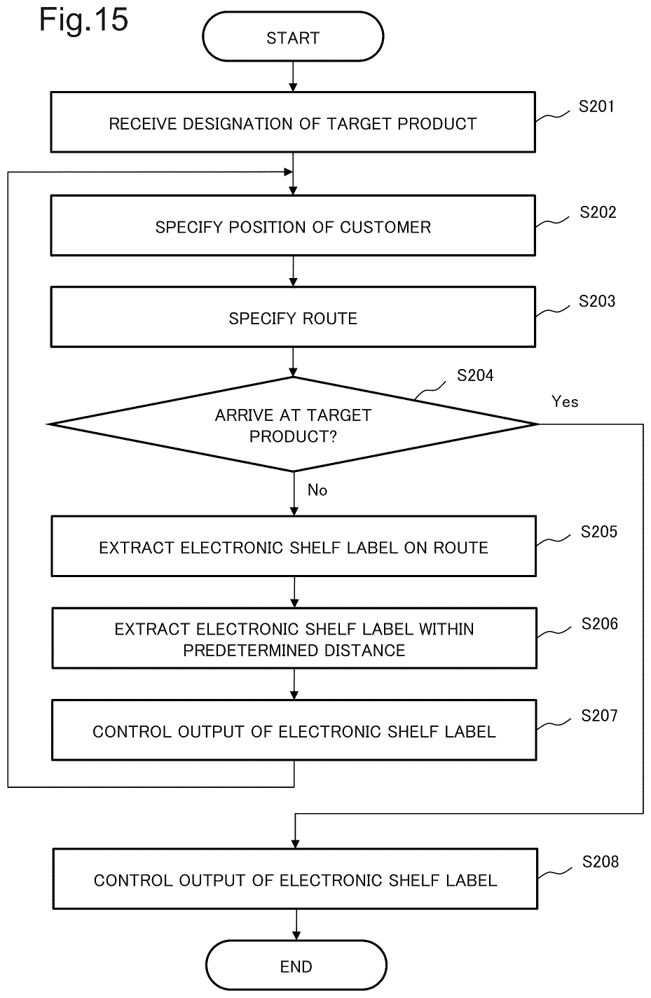

FIG. 15 is a flowchart illustrating an operation example of the control system 20 according to the second example embodiment. FIG. 15 illustrates an example of receiving the designation of the target product and controlling the display of the electronic shelf label D near the customer among the electronic shelf labels D on the path.

The product designation receiving unit 206 receives the designation of the target product according to the customer's operation on the terminal device 21 (step S201). The position specifying unit 201 specifies the position of the customer (step S202). In step S202, the position specifying unit 201 specifies the position of the customer by near field communication between the terminal device 21 of the customer and the device 22 (step S203).

The path specifying unit 202 specifies the path from the position of the customer to the position of the target product (step S204). In step S204, the path specifying unit 202 specifies the path from the position of the customer to the position of the electronic shelf label D associated with the target product based on the position information of the customer, the position information of the electronic shelf label D associated with the target product, and the layout information 2003.

The determining unit 205 determines whether the customer has arrived at the target product (step S204). In step S204, the determining unit 205 may determine whether the customer has arrived at the target product based on whether the position of the customer and the position of electronic shelf label D associated with the target product are within a predetermined distance. When the distance is within the predetermined distance, the determining unit 205 determines that the customer has arrived at the target product. When the distance is not within the predetermined distance, the determining unit 205 determines that the customer has not arrived at the target product.

When it is determined that the customer has not arrived at the target product (No in step S204), the extracting unit 203 extracts the electronic shelf label D on the path based on the position information of each electronic shelf label D (step S205). Then, the extracting unit 203 extracts the electronic shelf label D within a predetermined distance from the electronic shelf labels D on the path (step S206). Step S205 and step S206 may be performed by a single step.

Then, the output control unit 204 controls the output of the electronic shelf label D (step S207). In step S207, for example, the output control unit 204 displays the symbol indicating the traveling direction along the path on the display device 232 of the extracted electronic shelf label D. As described above, the example of displaying the symbol is an example, and is not particularly limited. The output control unit 204 performs control in such a way that the output of the electronic shelf label D that has not been newly extracted among the electronic shelf labels D extracted previously is returned to its original state. Returning to the original state means that, for example, in a case in which the symbol is being displayed on the display device 232 of the electronic shelf label D, the output control unit 204 displays the display product information associated with the electronic shelf label D on the display device 232 of the electronic shelf label D.

After step S207, the control system 20 causes the process to return to step S202. Accordingly, the control system 20 can re-specify the path even when the customer moves. The timing of initiating step S202 after step S207 is not particularly limited as described above. For example, the timing is not particularly limited and may be a timing specified by the target person, a timing after a predetermined time elapses, or a timing at which it is detected that the customer has moved a certain distance or more.

Next, in a case in which it is determined that the customer has arrived at the target product (Yes in step S204), the output control unit 204 controls the output of the electronic shelf label D (step S208). In step S208, for example, the output control unit 204 controls the output of the electronic shelf label D associated with the target product in such a way that the customer's arrival at the target product can be identified. For example, the output control unit 204 may cause the LED 231 of the electronic shelf label D associated with the target product to be blinked. The output control unit 204 displays the item information, which indicates the item associated with the electronic shelf label D on the path specified immediately before. Accordingly, the display of the electronic shelf label D returns to its original state.

In FIG. 15, after the process of specifying the path (step S203), the process of determining whether the customer has arrived at the target product (step S204) is executed. The order of the processes is not limited to this example, and the process of specifying the path (step S203) may be executed after the process of determining whether the customer has arrived at the target product (step S203). As described above, the order of the steps illustrated in FIG. 15 is not particularly limited, and may be appropriately changed.

As described above, in the second example embodiment, the case in which the facility is the store, the target person is the customer, and the target item is the target product has been described as an example, but these are not particularly limited as described in the first example embodiment.

As described above, in the second example embodiment, the control system 20 controls the output of the extracted electronic shelf label D in such a way that the path from the position of the target person to the target item can be identified. For example, the control system 20 controls the output of the extracted electronic shelf label D in such a way that the traveling direction along the specified path can be identified. More specifically, for example, the control system 20 displays at least one of the symbol indicating the traveling direction and the text indicating the traveling direction on the extracted electronic shelf label D.

For example, the path is the shortest path. Accordingly, the target person can find the target item in a shorter time. For example, the path is the path running through the specific item. Accordingly, it is possible to guide not only the target item but also the specific item to the target person.

The control system 20 extracts the electronic shelf label D within a predetermined distance from the position of the specified customer among the electronic shelf labels D on the path.

The control system 20 displays the item information indicating the item associated with the electronic shelf label D, on the electronic shelf label D other than the newly extracted electronic shelf label D among the electronic shelf labels D extracted previously. Accordingly, the displays of the electronic shelf labels D, other than the newly extracted electronic shelf label D among the electronic shelf labels D extracted previously, can be returned to their original state.

The control system 20 may determine whether the target person has arrived at the target item, and may extract the electronic shelf label D on the path when the target person has not arrived at the position of the target item. In a case in which the target person has arrived at the target item, the control system 20 outputs the information identifying the target item to the electronic shelf label D associated with the target item. Accordingly, the target person can more easily find the target item.

The target item may be an item designated by the target person. Accordingly, the target person can find the product being searched. The target product may be a product indicated by any product identification information in the list including the product identification information identifying the product that the target person is going to purchase. For example, the customer can easily find the product in the shopping list created in advance. Therefore, it is possible to shop in a shorter time.

The target item may be an item designated by the facility. Accordingly, the target person can easily find the item designated by the facility.

The description of the example embodiments is now concluded. The example embodiments may be used in combination. For example, in each example embodiment, the control system may have configurations in which the functional units and some pieces of information are included. For example, in the second example embodiment, the control system 20 may have a configuration including the position specifying unit 201, the path specifying unit 202, the extracting unit 203, the output control unit 204, and the determining unit 205.

The configuration of the electronic shelf label is not particularly limited. The electronic shelf label may have a configuration including a part of the above-described configuration. For example, the electronic shelf label may have a configuration including a display device.

Each example embodiment is not limited to the above-described example, and various modifications can be made. The control system may be implemented by a single device (for example, a single server, a single terminal device, or the like), or may be implemented by a plurality of different devices (a plurality of servers) depending on information or a function.

In each example embodiment, each piece of information may include part of the information described above. Each piece of information may include information other than the above-described information. A method for implementing each piece of information is not particularly limited. Each piece of information may be divided into a plurality of pieces of information in further detail. A plurality of pieces of information may be obtained as one piece of information. For example, the shelf label DB 2001 and the product DB 2002 described in the second example embodiment have been described as the separate DBs, but may be implemented by a single DB. As described above, a method for implementing each piece of information is not particularly limited.

For example, in the second example embodiment, the process of generating information of a screen or the like to be displayed on the display device of the terminal device may be performed by the control system or may be performed by the terminal device.

### (Computer Device)

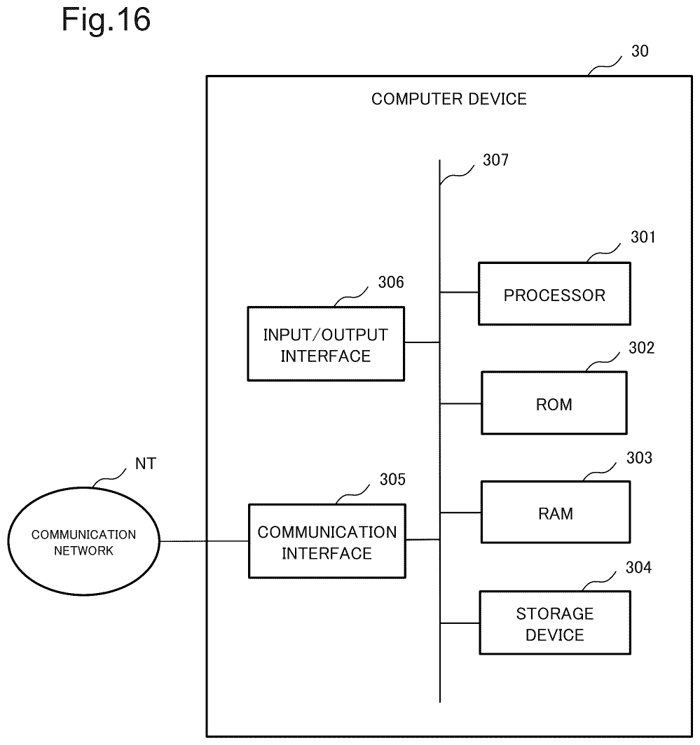

Next, a hardware configuration example in a case in which the control system described in each example embodiment is implemented by a computer device will be described. FIG. 16 is an explanatory diagram illustrating a hardware configuration example of a computer device. For example, some or all of the devices can be implemented, for example, by using a certain combination of a computer device 30 illustrated in FIG. 16 and a program.

The computer device 30 includes, for example, a processor 301, a read only memory (ROM) 302, and a random access memory (RAM) 303. The computer device 30 further includes, for example, a storage device 304, a communication interface 305, and an input/output interface 306. The components are connected via a bus 307.

The processor 301 controls the entire computer device 30. Examples of the processor 301 include a central processing unit (CPU), a digital signal processor (DSP), and the like. The number of processors 301 may be two or more. The computer device 30 includes the ROM 302, the RAM 303, the storage device 304, and the like as storage units. Examples of the storage device 304 include a semiconductor memory such as a flash memory, a hard disk drive (HDD), a solid state drive (SSD), and the like. For example, the storage device 304 stores an operating system (OS) program, an application program, a program according to each example embodiment, and the like. Alternatively, the ROM 302 stores an application program, a program according to each example embodiment, and the like. Then, the RAM 303 is used as a work area of the processor 301.

The processor 301 loads a program stored in the storage device 304, the ROM 302, or the like. Then, the processor 301 executes each process (each processing instruction) coded in a program. The processor 301 may download various programs via the communication network NT. The processor 301 functions as the whole or part of the computer device 30. Then, the processor 301 may execute the processes or the instructions in the illustrated flowcharts based on the program.

The communication interface 305 is connected to a communication network NT such as a local area network (LAN) or a wide area network (WAN) via a wireless or wired communication line. The communication network NT may include a plurality of communication networks NT. Accordingly, the computer device 30 is connected to an external device or an external computer device 30 via the communication network NT. The communication interface 305 is responsible for an interface between the communication network NT and the inside of the computer device 30. Then, the communication interface 305 controls input/output of data to/from an external device or an external computer.

The input/output interface 306 is connected to at least one of an input device, an output device, and an input/output device. A connection method may be wireless or wired. Examples of the input device include a keyboard, a mouse, and a microphone. Examples of the output device include a display device, a lighting device, and a speaker that is a voice output device that outputs a voice. The input/output device includes a touch panel display or the like. Note that the input device, the output device, the input/output device, and the like may be built in the computer device 30 or may be externally attached.

The hardware configuration of the computer device 30 is an example. The computer device 30 may have some of the components illustrated in FIG. 16. The computer device 30 may have components other than those illustrated in FIG. 16. For example, the computer device 30 may include a drive device or the like. Then, the processor 301 may read a program or data stored in a recording medium mounted to the drive device or the like out to the RAM 303. Examples of the non-transitory tangible recording medium include an optical disk, a flexible disk, a magnetic optical disk, and a universal serial bus (USB) memory. As described above, for example, the computer device 30 may include an input device such as a keyboard or a mouse. The computer device 30 may have an output device such as a display. The computer device 30 may include an input device, an output device, and an input/output device.

The computer device 30 may include various sensors (not illustrated). The type of the sensor is not particularly limited. The sensor may be, for example, an acceleration sensor, a gyro sensor, a magnetic sensor, a global positioning system (GPS) sensor, a fingerprint sensor, or the like. The sensor may be a LiDAR (light, detection and ranging), a proximity sensor, an ambient light sensor, or the like.

The description of the hardware configuration of the control system is now concluded. The method of implementing the control system may have modifications. For example, the control system may be implemented by a certain combination of a computer device and a program which differ for each a component. A plurality of components included in the control system may be implemented by a certain combination of one computer device and a program.

The whole or part of each component of the control system may be implemented by a specific-purpose circuit. The whole or part of the control system may be implemented by a general-purpose circuit including a processor such as a field programmable gate array (FPGA). The whole or part of the control system may be implemented by a combination of a specific-purpose circuit, a general-purpose circuit, and the like. These circuits may be implemented by a single integrated circuit. Alternatively, these circuits may be divided into a plurality of integrated circuits. A plurality of integrated circuits may be connected via a bus or the like.

In a case in which the whole or part of each component of each device is implemented by a plurality of computer devices, circuits, or the like, a plurality of computer devices, circuits, or the like may be arranged in a centralized manner or in a distributed manner.

The control method described in each example embodiment is implemented by execution by a computer device such as the control system. The control method is implemented by executing a program prepared in advance by a computer device such as the control system. The program described in each example embodiment is recorded in a computer-readable recording medium such as an HDD, an SSD, a flexible disk, an optical disk, a flexible disk, a magnetic optical disk, or a USB memory. Then, the program is read from the recording medium and executed by the computer device. Further, the program may be distributed via the communication network NT.

Each component of the control system in each example embodiment described above may be implemented hardware-wise, similarly to a computer device. Alternatively, each component may be implemented by a computer device or firmware based on program control.

Although the present disclosure has been described with reference to the respective example embodiments, the present disclosure is not limited to the above example embodiments. The configuration and details of each of the present disclosure may include example embodiments to which various changes that can be conceived by those skilled in the art within the scope of the present disclosure are applied. The present disclosure may include example embodiments in which the matters described in the present specification are appropriately combined or replaced as necessary. For example, the matters described using a specific example embodiment can be applied to the other example embodiments as long as no contradiction occurs. For example, although a plurality of operations is described in order in the form of a flowchart, the order of description does not limit the order of executing a plurality of operations. Therefore, when each example embodiment is implemented, the order of a plurality of operations can be changed to the extent that the substance of the content is not affected.

Some or all of the above example embodiments may be described as in the following supplementary notes. However, some or all of the above example embodiments are not limited to the following supplementary notes.

### (Supplementary Note 1)

A control system including:
a position specifying means configured to specify a position of a target person in a facility;
a path specifying means configured to specify a path from the specified position to a position of a target item;
an extracting means configured to extract an electronic shelf label on the path based on position information indicating a position of each electronic shelf label in the facility; and an output control means configured to control an output of the extracted electronic shelf label.

### (Supplementary Note 2)

The control system according to supplementary note 1, wherein
the output control means controls an output of at least one of a display device and a lighting device of the electronic shelf label on the path.

### (Supplementary Note 3)

The control system according to supplementary note 1 or 2, wherein
the output control means controls an output of the extracted electronic shelf label in such a way that the specified path can be identified.

### (Supplementary Note 4)

The control system according to supplementary note 3, wherein
the output control means displays at least one of a symbol indicating the path and text indicating the path on the extracted electronic shelf label.

### (Supplementary Note 5)

The control system according to supplementary note 4, wherein
the at least one of the symbol indicating the path and text indicating the path indicates a traveling direction along the path.

### (Supplementary Note 6)

The control system according to any one of supplementary notes 1 to 5, wherein
the path is the shortest path among a plurality of paths from the specified position to the position of the target item.

### (Supplementary Note 7)

The control system according to any one of supplementary notes 1 to 6, wherein
the path is a path running through a specific item.

### (Supplementary Note 8)

The control system according to any one of supplementary notes 1 to 7, wherein
the extracting means extracts an electronic shelf label within a predetermined distance from the specified position, among the electronic shelf labels on the path.

### (Supplementary Note 9)

The control system according to any one of supplementary notes 1 to 8, wherein
the output control means displays item information indicating an item associated with the electronic shelf label, on the electronic shelf label that is on the path specified immediately before and is not on the path specified newly.

### (Supplementary Note 10)

The control system according to any one of supplementary notes 1 to 9, further including
a determining means configured to determine whether the target person has arrived at the target item,
wherein the extracting means newly extracts the electronic shelf label on the path in a case in which the target person has not arrived at the target item.

### (Supplementary Note 11)

The control system according to supplementary note 10, wherein
the output control means outputs information identifying a position of the target item to an electronic shelf label associated with the target item.

### (Supplementary Note 12)

The control system according to supplementary note 11, wherein
the output control means displays item information indicating an associated item on the path specified immediately before.

### (Supplementary Note 13)

The control system according to any one of supplementary notes 1 to 11, wherein
the target item is an item designated by the target person.

### (Supplementary Note 14)

The control system according to any one of supplementary notes 1 to 13, wherein
the facility is a store, and
the target item is a target product.

### (Supplementary Note 15)

The control system according to supplementary note 14, wherein
the target product is a product indicated by any product identification information in a list including product identification information identifying a product that the target person is going to purchase.

### (Supplementary Note 16)

The control system according to supplementary note 15, wherein
the path specifying means specifies a path from the specified position to a position of a product indicated by each of a plurality of pieces of product identification information included in the list.

### (Supplementary Note 17)

The control system according to any one of supplementary notes 1 to 13, wherein
the facility is a factory.

### (Supplementary Note 18)

The control system according to any one of supplementary notes 1 to 17, wherein
the position of the target item is a position of an electronic shelf label on which item information of the target item is displayed.

### (Supplementary Note 19)

The control system according to any one of supplementary notes 1 to 18, wherein
the position specifying means newly specifies the position of the target person at any one of a timing specified by the target person, a timing at which a predetermined time elapses after the position is specified, and a timing at which it is detected that the target person has moved a predetermined distance or more.

### (Supplementary Note 20)

A control method, including:
specifying a position of a target person in a facility;
specifying a path from the specified position to a position of a target item;
extracting an electronic shelf label on the path based on position information indicating a position of each electronic shelf label in the facility; and
controlling an output of the extracted electronic shelf label.

### (Supplementary Note 21)

A non-transitory recording medium readable by a computer and having a program recorded therein, the program causing the computer to execute a process of:
specifying a position of a target person in a facility;
specifying a path from the specified position to a position of a target item;
extracting an electronic shelf label on the path based on position information indicating a position of each electronic shelf label in the facility; and
controlling an output of the extracted electronic shelf label.

### (Supplementary Note 22)

A program causing a computer to execute a process of
specifying a position of a target person in a facility,
specifying a path from the specified position to a position of a target item,
extracting an electronic shelf label on the path based on position information indicating a position of each electronic shelf label in the facility, and
controlling an output of the extracted electronic shelf label.

### REFERENCE SIGNS LIST

10, 20 control system
21 terminal device
22, 22-1, 22-2, 22-3, 22-4 device
30 computer device
101, 201 position specifying unit
102, 202 path specifying unit
103, 203 extracting unit
104, 204 output control unit
205 determining unit
206 product designation receiving unit
231 LED
232 display device
301 processor
302 ROM
303 RAM
304 storage device
305 communication interface
306 input/output interface
307 bus
2003 layout information
A, A1, A2 shelf
D, D1, D3, D4, D5, D6 electronic shelf label
2001 shelf label DB
2002 product DB
2003 layout information
NT communication network

What is claimed is:

1. A control system comprising:
at least one memory storing instructions; and
at least one processor configured to execute the instructions to:
specify a position of a target person in a facility;
specify a path from the specified position to a position of a target item;
extract an electronic shelf label on the path based on position information indicating a position of each electronic shelf label in the facility; and
control an output of the extracted electronic shelf label.

2. The control system according to claim 1, wherein the at least one processor is further configured to execute the instructions to:
the control an output of at least one of a display device and a lighting device of the electronic shelf label on the path.

3. The control system according to claim 1, wherein the at least one processor is further configured to execute the instructions to:
control the output of the extracted electronic shelf label in such a way that the specified path can be identified.

4. The control system according to claim 3, wherein the at least one processor is further configured to execute the instructions to:
display at least one of a symbol indicating the path and text indicating the path on the extracted electronic shelf label.

5. The control system according to claim 4, wherein
the at least one of the symbol indicating the path and text indicating the path indicates a traveling direction along the path.

6. The control system according to claim 1, wherein
the path is the shortest path among a plurality of paths from the specified position to the position of the target item.

7. The control system according to claim 1, wherein
the path is a path running through a specific item.

8. The control system according to claim 1, wherein the at least one processor is further configured to execute the instructions to:
extract an electronic shelf label within a predetermined distance from the specified position, among the electronic shelf labels on the path.

9. The control system according to claim 1, wherein the at least one processor is further configured to execute the instructions to:
display item information indicating an item associated with the electronic shelf label, on the electronic shelf label that is on the path specified immediately before and is not on the path specified newly.

10. The control system according to claim 1, the at least one processor is further configured to execute the instructions to:
determine whether the target person has arrived at the target, item and
newly extracts newly extract the electronic shelf label on the path in a case in which the target person has not arrived at the target item.

11. The control system according to claim 10, wherein the at least one processor is further configured to execute the instructions to:
output information identifying a position of the target item to an electronic shelf label associated with the target item.

12. The control system according to claim 11, wherein the at least one processor is further configured to execute the instructions to:
display item information indicating an associated item on the electronic shelf label on the path specified immediately before.

13. The control system according to claim 1, wherein
the target item is an item designated by the target person.

14. The control system according to claim 1, wherein
the facility is a store, and
the target item is a target product.

15. The control system according to claim 14, wherein
the target product is a product indicated by any product identification information in a list including product identification information identifying a product that the target person is going to purchase.

16. The control system according to claim 15, wherein the at least one processor is further configured to execute the instructions to:
specify a path from the specified position to a position of a product indicated by each of a plurality of pieces of product identification information included in the list.

17. (canceled)

18. The control system according to claim 1, wherein
the position of the target item is a position of an electronic shelf label on which item information of the target item is displayed.

19. The control system according to claim 1, wherein the at least one processor is further configured to execute the instructions to:
newly specify the position of the target person at any one of a timing specified by the target person, a timing at which a predetermined time elapses after the position is specified, and a timing at which it is detected that the target person has moved a predetermined distance or more.

20. A control method comprising:
specifying a position of a target person in a facility;
specifying a path from the specified position to a position of a target item;
extracting an electronic shelf label on the path based on position information indicating a position of each electronic shelf label in the facility; and
controlling an output of the extracted electronic shelf label.

21. A non-transitory recording medium readable by a computer and having a program recorded therein, the program causing the computer to execute a process of:
specifying a position of a target person in a facility;
specifying a path from the specified position to a position of a target item;
extracting an electronic shelf label on the path based on position information indicating a position of each electronic shelf label in the facility; and
controlling an output of the extracted electronic shelf label.
